(19) United States
(12) Patent Application Publication
(10) Pub. No.: US 2007/0121911 A1
(43) Pub. Date: May 31, 2007

(54) Phone number traceability based on service discovery

(75) Inventors: Daniel A. Baudino, Lake Worth, FL (US); Tasos Anastasakos, San Jose, CA (US); Von A. Mock, Boynton Beach, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/286,740

(22) Filed: Nov. 25, 2005

(51) Int. Cl. H04M 1/00; H04M 3/00

(52) U.S. Cl. 379/355.04

(57) ABSTRACT

A system (30) or method (100) of updating a calling party's phonebook (32) can include tracking (102) location information of at least a party that is an entry in the calling party's phonebook, storing (104) the location information at a server (15), and checking (106) the server for an updated contact number for a called party before completing a call setup to a the called party. The method can further include completing (108) the call to the updated contact number. The method can further include updating (110) the calling party's phonebook at a mobile device (13) or at fixed network equipment (15 or 16) by using the information from the server. The method can further include detecting (112) a context of a called party and routing calls to the called party based on a called party preference.

### FIELD

This invention relates generally to communications, and more particularly to a communication system and service capable of tracing a called party.

### BACKGROUND

A typical call forwarding system does not guarantee or necessarily improve the odds that a call will be completed. Some call forwarding systems merely sequentially dial one phone number after another until a call is completed. Such systems fail to efficiently trace or track called parties before they are called. Sometimes called parties do not necessarily want to receive calls at their cell phone when they are at home (particularly when the cellular system involves payment by the receiving party). In most instances called parties would rather receive phone calls at their home phone number when they are at home. Some called parties would like to receive calls at their cell phone (redirected from the home phone) when they are away.

### SUMMARY

In a first embodiment of the present invention, a method of updating a calling party's phonebook can include the steps of tracking location information of at least a party that is an entry in the calling party's phonebook, storing the location information at a server, and checking the server for an updated contact number for a called party before completing a call setup to a the called party. The method can further include completing the call to the updated contact number. The method can further include updating the calling party's phonebook at a mobile device or at fixed network equipment by using the information from the server. The method can further include detecting a context of a called party and routing calls to the called party based on a called party preference. Note, the step of tracking location information can use a satellite positioning system (SPS) satellite, base station location identifiers, cellular beacons, in-home location beacons, IP addressing, computer log-in records, or caller identification information to provide location information to the server. Also note, the step of storing the location information at the server can involve storing location information at a service discovery database communicatively coupled to the server.

In a second embodiment of the present invention, a system for updating a calling party's phonebook can include a wireless communication device, a phonebook stored in a memory within the wireless communication device having a plurality of entries corresponding to called party entries, a server in communication with the wireless communication device containing a database of updated location information for at least some of the plurality of entries, and a processor within the wireless communication device programmed to check the server for an updated contact number for a called party before completing a call setup to the called party. The processor can be further programmed to complete a call to the updated contact number or to update the phonebook at the wireless communication device or at fixed network equipment by using the information from the server. The processor can also be programmed to detect a context of a called party and routing calls to the called party based on a called party preference. The processor can also track location information of a called party by using an SPS satellite, base station location identifiers, cellular beacons, in-home location beacons, IP addressing, computer log-in records, or caller identification information to provide location information to the server. The system can further include a service discovery database communicatively coupled to the server for storing the updated location information.

In a third embodiment of the present invention, a wireless communication device can include a transceiver, a calling party's phonebook communicatively coupled to the transceiver, and a processor coupled to the transceiver. The processor can be programmed to obtain updated contact information from a server communicatively coupled to the transceiver for a called party before completing a call setup to the called party. Note, the wireless communication device can be inhibited from revealing location information of a called party to the calling party. The processor can be programmed to complete the call to the updated contact number and to update the calling party's phonebook at the wireless communication device or at fixed network equipment by using the information from the server. The processor can further be programmed to detect a context of a called party and routing calls to the called party based on a called party preference.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a system for updating a calling party's phonebook in accordance with an embodiment of the present invention.

FIG. 2 is an illustration of another system for updating a calling party's phonebook in accordance with an embodiment of the present invention.

FIG. 3 is an illustration of another system for updating a calling party's phonebook in accordance with an embodiment of the present invention.

FIG. 4 is an illustration of another system for updating a calling party's phonebook in accordance with an embodiment of the present invention.

FIG. 5 is an illustration of another system for updating a calling party's phonebook in accordance with an embodiment of the present invention

FIG. 6 is a flow chart illustrating a method of updating a calling party's phonebook in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

The call-forward system implemented by MCI calls three numbers in sequence until the user or called party is reached. In another existing system, location tracking is used for indoor location finding (using proximity sensors) to transfer calls to the closest location for the user without checking for user preferences or making changes automatically. In one embodiment, a system as contemplated herein can dynamically check the user or called party location and call or call-forward directly to the right number. In other words, embodiments herein can provide automatic user discovery for phone traceability. Other embodiments can further provide an adaptive phonebook based on a calling party or user current location as well as automatic call routing based on the calling party or user current location

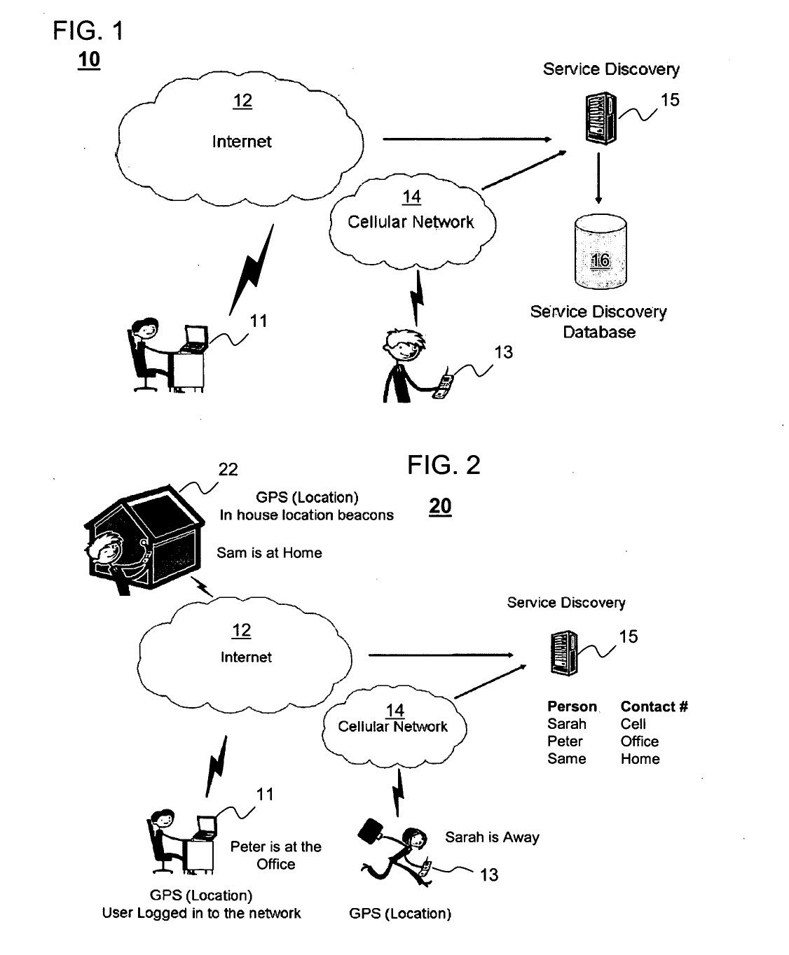

As illustrated in a communication system 10 of FIG. 1, a called party 11 or 13 can be traced and such updated information can be made available via a cellular network 14 or the internet 12 at a service discovery server 15 containing a service discovery database 16. The system 10 can update such information for a calling party by adapting the calling party's phone book or by call-forwarding based on the information obtained from the service discovery server 15. Referring to the communication system 20 of FIG. 2, different entries on a phonebook or potential called parties can be traced or registered with the service discovery server 15. For example, a home user “Sam” can have a device 22 that indicates that he is at home. The device 22 can be an in-home location beacon that registers his presence via the internet 12 to the service discovery server 15. Another user named “Peter” can be logged on to a computer system at their office using a computer 11 and also register their presence via the internet 12 to the service discovery server 15. Likewise, a user named “Sarah” can have a cellular phone 13 having location tracking services such as a GPS device that can register her location via the cellular network 14 to the service discovery server 15. Optionally, the respective users or potential called parties (11, 13, or 22) can add to the registration phone numbers/e-mail addresses that they can be reached and their phone of preference or other preferences. The service discovery server 15 can allow the user or potential called party to enter which user or calling party can receive the information and what information can be shared.

Once the user is registered, the service is ready to start tracking the user location. The user tracking be done using the satellite positioning system satellites (GPS or Assisted GPS), location beacons (cellular beacons, in-home location beacons), home/office computer, IP addressing, base station location identifiers, computer log-in records, caller identification information or other information to provide location information to the service discovery server 15. Optionally, the location information is not made available to anybody. In some embodiments, only the contact number information may be made available and in other embodiments, not even the contact number is shared.

The service discovery can be updated by events (drastically changing positions, reaching a point-i.e. home-, etc.). The service/discovery update can be done using SMS, e-mail packet data, or automatically done by the network for assisted GPS or AGPS.

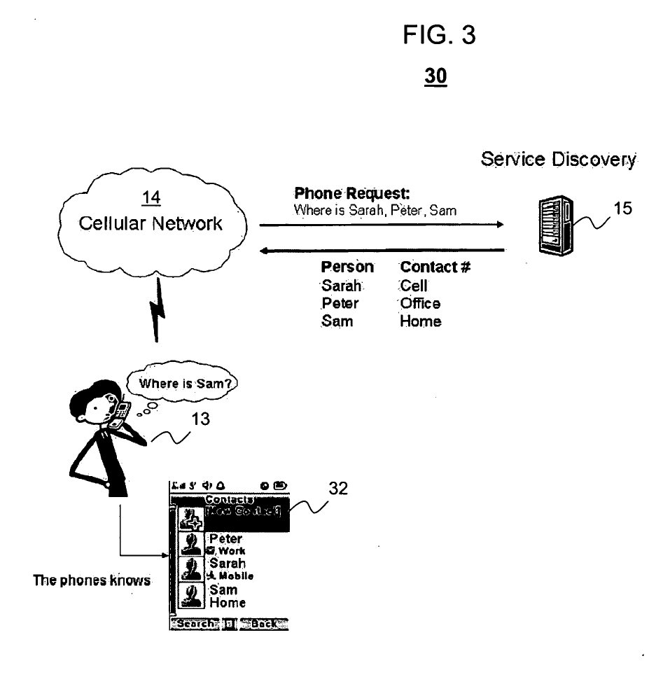

In one embodiment, an intelligent phonebook 32 can be used. The phone book of people subscribed to the service discovery will automatically update. For example, referring to the system 30 of FIG. 3, if somebody (such as a calling party 13) wants to call Sarah, he/she does not need to guess where Sarah is, the phone book will automatically communicate with the discovery service server 15 and obtain the current location and updated contact number or phone number. When the user 13 presses send on Sarah's name in the phonebook 32, the phone number pointing on the phone book is Sarah's cell phone number at the current location. If Sarah is away, the cellular phone's contact lists points to the cell phone number or when she is at home the contact list points to Sarah's home phone number, or the phone number pointing on the phone book 32 can be redirected to any phone of Sarah's preference. For example, although she may be on her cellular phone at her home, she may set a preference to have calls automatically call her home or forward to her home number when she is at home. In other words, the user (the called party) can request the service to route the calls to the phone where the user is at. For example, if the user is away and receives a phone call at the home phone number, the service automatically routes the call to the cell phone number (after the call is screened using a friendly filter list).

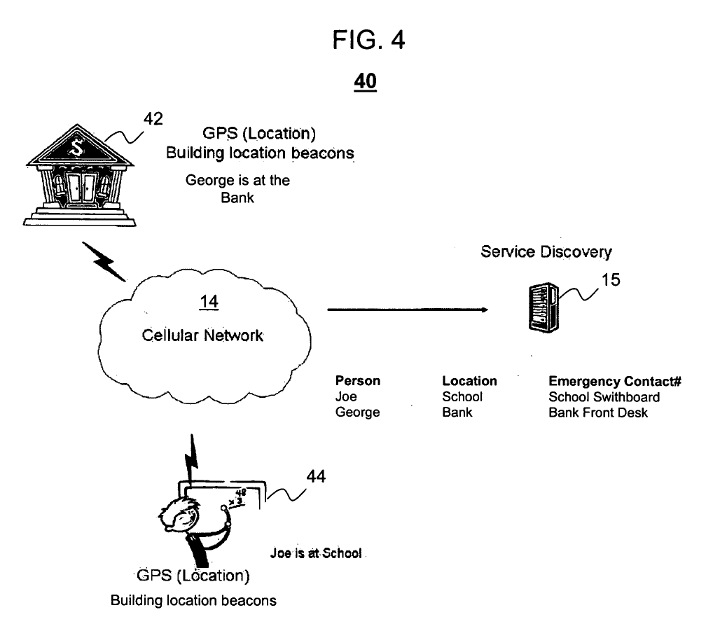

When the called party is in a zone where mobile phones are banned (i.e. Schools, banks, etc), the user may not be able to be reached. If a calling party needs to communicate to the user for an emergency, then the system can automatically route the calling party to a location front or desk/switchboard, etc. at the school 44 or bank 42 or other banned zone as illustrated in FIG. 4. The new phone number acts as a proxy to route the emergency call so anybody can be reached on an emergency. For example, if a person is in a mall, and cannot be reached due to a lack of service (at the receiving end), then the emergency call can be routed to the Mall switch board and the person inside the mall can be reached using a Mall intercom.

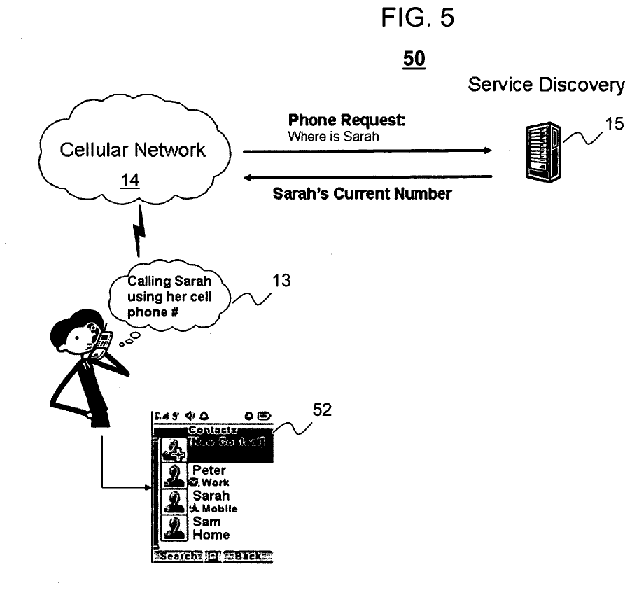

Referring to FIG. 5, instead of updating a calling party's entire phonebook 52, a system 50 can update just one phone number (i.e. cell phone number) and the calling party 13 can request that the service discovery server 15 provide the phone number or contact number at the current location.

In yet another embodiment, the context of a potential called party (found as an entry in the calling party's phonebook) that subscribes to the service can also be included on the service discovery database. For example, if the called party or user is driving (the phone can easily detect that the user is driving using GPS or other location finding means), then he or she might want to have all the calls redirected to their voice mail. Also, the context can be automatically detected as well as manually entered. For example, if the user does not want to be bothered (i.e. when the user is in a meeting), then the status can be manually changed.

If the called party being reached is in an out-of-service area (mobile device is off, unreachable, etc), then the caller usually leaves a voice mail. After that, the message can be routed to the location where the user is at (last detected location). If the user does not check the message, then once the user enters a location that can be reached (login in into the office computer, gets home, etc assuming that the mobile phone is still unreachable), then the user can check their messages. The system can also play a message to the calling party to inform that the user is not reachable, out of area, etc.

As mentioned above, the called party or user can define a preferred way of contact. As a user moves to different environments, his or her personal device can sense a situation and transmit such status to the service discovery server 15 in order to change the address book preferences accordingly. The phone can sense additional ways of communication in new environments and prompt the user to accept these before they are sent to the server, either during a discovery process or as a confirmation when the context changes. For example, if the user is at their workspace and the phone can sense that there is a computer, it can ask whether the user would prefer communication to be received as e-mail or IM for that location. If the user accepts, then this information is sent to the server and kept for future use as well.

The service discovery server 15 can also learn about the user based on past experiences (i.e., user is typically at home during the weekend, and off work hours). Then the call can be routed to the proper place based on the past tracked history of the user. If the user is still on the road and has no service on the mobile phone, the service can guess the future location and route the messages to such projected location or device.

The user current location/status can be kept private. All information can be transparent to the calling party to maintain privacy. The phone can handle the contact information hidden from the calling party so the calling party does not have a way to know where the user or called party is at unless the user receiving the call tells the system to reveal the information/location (by setting such preferences).

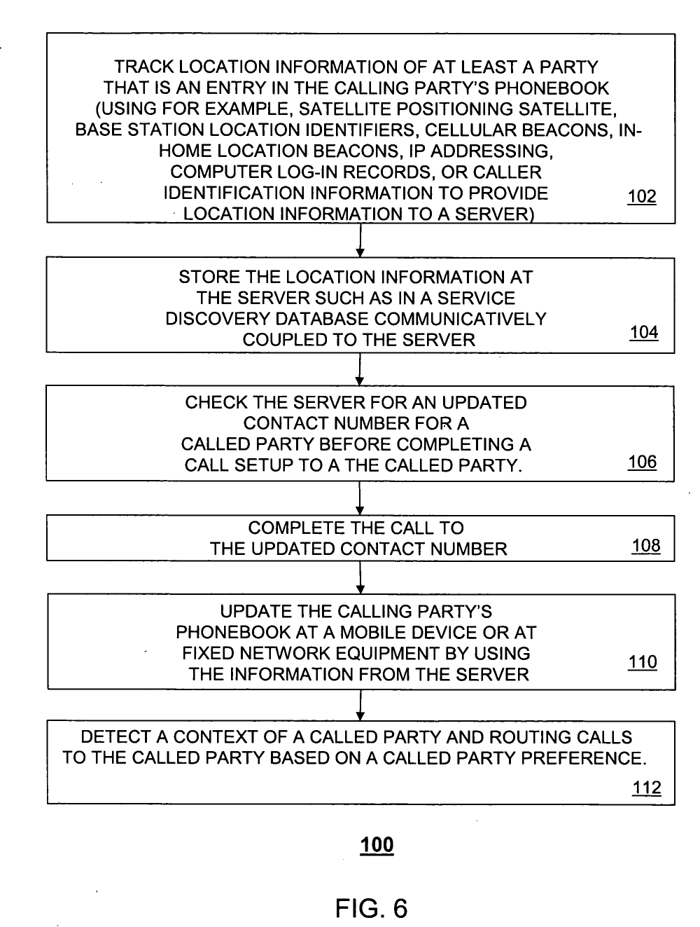

Referring to FIG. 6, a flow chart illustrating a method 100 of updating a calling party's phonebook can include the step 102 of tracking location information of at least a party that is an entry in the calling party's phonebook, storing the location information at a server at step 104, and checking the server for an updated contact number for a called party before completing a call setup to a the called party at step 106. The method 100 can further include completing the call to the updated contact number at step 108. The method 100 can further include updating the calling party's phonebook at a mobile device or at fixed network equipment by using the information from the server at step 110. The method 100 can further include the step 112 of detecting a context of a called party and routing calls to the called party based on a called party preference. Note, the step of tracking location information can use a satellite positioning system satellite, base station location identifiers, cellular beacons, in-home location beacons, IP addressing, computer log-in records, or caller identification information to provide location information to the server. Also note, the step of storing the location information at the server can involve storing location information at a service discovery database communicatively coupled to the server.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of updating a calling party's phonebook, comprising the steps of:
tracking location information of at least a party that is an entry in the calling party's phonebook;
storing the location information at a server; and
checking the server for an updated contact number for a called party before completing a call setup to a the called party.

2. The method of claim 1, wherein the method further comprises the step of completing the call to the updated contact number.

3. The method of claim 1, wherein the method further comprises the step of updating the calling party's phonebook at a mobile device by using the information from the server.

4. The method of claim 1, wherein the method further comprises the step of updating the calling party's phonebook at fixed network equipment by using the information from the server.

5. The method of claim 1, wherein the method further comprises the step of detecting a context of a called party and routing calls to the called party based on a called party preference.

6. The method of claim 1, wherein the step of tracking location information comprises the step of using a satellite positioning system satellite, base station location identifiers, cellular beacons, in-home location beacons, IP addressing, computer log-in records, or caller identification information to provide location information to the server.

7. The method of claim 1, wherein the step of storing the location information at the server comprises storing location information at a service discovery database communicatively coupled to the server.

8. The method of claim 2, wherein the method further comprises the step of automatically routing the calling party to a location front or desk/switchboard when the called party is in a zone where mobile phones are known to be banned or unreachable whereby enabling a new phone number to act as a proxy to route calls to the called party.

9. A system for updating a calling party's phonebook, comprising:
a wireless communication device;
a phonebook stored in a memory within the wireless communication device having a plurality of entries corresponding to called party entries;
a server in communication with the wireless communication device containing a database of updated location information for at least some of the plurality of entries; and
a processor within the wireless communication device programmed to check the server for an updated contact number for a called party before completing a call setup to the called party.

10. The system of claim 9, wherein the processor is programmed to complete a call to the updated contact number.

11. The system of claim 9, wherein the processor is programmed to update the phonebook at a wireless communication device by using the information from the server.

12. The system of claim 9, wherein the processor is programmed to update the calling party's phonebook at fixed network equipment by using the information from the server.

13. The system of claim 9, wherein the processor is programmed to detect a context of a called party and routing calls to the called party based on a called party preference.

14. The system of claim 9, wherein the processor is programmed to track location information of a called party by using a satellite positioning system satellite, base station location identifiers, cellular beacons, in-home location beacons, IP addressing, computer log-in records, or caller identification information to provide location information to the server.

15. The system of claim 9, wherein the system further comprises a service discovery database communicatively coupled to the server for storing the updated location information.

16. The system of claim 10, wherein the processor is further programmed to automatically route the calling party to a location front or desk/switchboard when the called party is in a zone where mobile phones are known to be banned or unreachable whereby enabling a new phone number to act as a proxy to route calls to the called party.

17. A wireless communication device, comprising:
a transceiver;
a calling party's phonebook communicatively coupled to the transceiver; and
a processor coupled to the transceiver, wherein the processor is programmed to:
obtain updated contact information from a server communicatively coupled to the transceiver for a called party before completing a call setup to the called party.

18. The wireless communication device of claim 17, wherein the wireless communication device is inhibited from revealing location information of a called party to the calling party.

19. The wireless communication device of claim 17, wherein processor is further programmed to complete the call to the updated contact number.

20. The wireless communication device of claim 17, wherein processor is further programmed to detect a context of a called party and routing calls to the called party based on a called party preference.
